(19) United States
(12) Patent Application Publication
(10) Pub. No.: US 2025/0392488 A1
(43) Pub. Date: Dec. 25, 2025

(54) SYSTEM AND METHOD FOR PROVISIONING INTERWORKING OF COMMUNICATION NETWORKS WITH DIFFERENT RADIO ACCESS TECHNOLOGIES

(71) Applicant: JIO PLATFORMS LIMITED, Ahmedabad (IN)

(72) Inventors: Aayush BHATNAGAR, Navi Mumbai (IN); Mukta SHETTY, Thane, Maharashtra (IN); Puneet PAREEK, Sikar, Rajasthan (IN); Yugandhara JOSHI, Amravati, Maharashtra (IN); Apoorva KHAMESRA, Udaipur, Rajasthan (IN); Aditya GUPTA, Karnal, Haryana (IN)

(73) Assignee: JIO PLATFORMS LIMITED, Ahmedabad (IN)

(21) Appl. No.: 18/880,341

(22) PCT Filed: Jul. 29, 2023
(86) PCT No.: PCT/IB2023/057738

§ 371 Date: Dec. 31, 2024

(30) Foreign Application Priority Data
Jul. 30, 2022 (IN) 202221043742

(51) Int. Cl. H04L 12/14; H04M 15/00

(52) U.S. Cl. CPC H04L 12/1407; H04M 15/64; H04M 15/65; H04M 15/66; H04M 15/8038

(57) ABSTRACT

The present disclosure provides a system and a method for provisioning interworking of communication networks. The method includes receiving a service request from a first charging function based on a first protocol format, wherein the first charging function is associated with a first communication network having a first radio access technology (RAT), converting the received service request to a second protocol format, wherein the second protocol format is associated with a second charging function at a second communication network having a second RAT, receiving a response message for the service request based on the second protocol format from the second charging function and converting the received response message to the first protocol format associated with the first charging function.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to Fourth Generation (4G) and 5G interworking technologies. More particularly, the present disclosure relates to a protocol convertor for interworking of 4G and 5G networks.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Fifth generation (5G) core network includes various network functions (NFs) to cater different services to be performed by the 5G Core. One such function of 5G core is the Charging Function (CHF). The CHF and was introduced to perform the functionalities similar to online charging system (OCS) and offline charging system (OFCS) defined with respect to 4G network. Further, the CHF may also interact with other 5G NFs such as session management function (SMF) and policy control function (PCF) over hypertext transfer protocol/2 (HTTP/2).

The introduction of the CHF, however, introduced a set of challenges for existing network operators. Some of the challenges faced by the existing network operators were:
(i) The business support system (BSS) is integrated with 4G OCS/OFCS, hence integration of new CHF function for 5G Core would introduce additional complexity.
(ii) Integration challenges related to charging for usage associated with non-combo packet network data gateway (PGW) vs SMF.
(iii) Using the existing BSS without making major changes
(iv) Upgrading the existing OCS/OFCS to support HTTP/2 stack and new services required huge effort, customizations and detailed testing for both new services as well as existing use case.

In view of the above challenges, there is a need for a solution to support 5G without altering the existing BSS.

There is, therefore, a need in the art to provide a method and a system that can overcome the shortcomings of the existing prior arts.

### OBJECTS OF THE PRESENT DISCLOSURE

Some of the objects of the present disclosure, which at least one embodiment herein satisfies are as listed herein below.

An object of the present disclosure to provide a charging function protocol converter (CHF-PC) which may act as gateway to 4G online charging system (OCS) for 5G Interface Interactions.

An object of the present disclosure to enable the CHF-PC to provide the functionality of CHF for 5G Core nodes.

An object of the present disclosure to provide protocol conversion from hypertext transfer protocol/2 (HTTP/2) format to Diameter protocol format and vice versa.

An object of the present disclosure to provide conversion of Nchf_SpendingLimitControl Service to Sy Interface and vice versa.

An object of the present disclosure to provide conversion of Nchf_ConvergedCharging Service to Gy Interface and vice versa.

An object of the present disclosure to provide registration of the CHF-PC with network repository function (NRF) as CHF Network Function (NF) for discovery and use by other NFs like policy control function (PCF)/session management function (SMF)/access and mobility management function (AMF)/short message service function (SMSF), etc.

An object of the present disclosure to enable the CHF-PC to connect with session control protocol (SCP) for sending/receiving messages from Peer 5G NFs over HTTP/2 interface.

An object of the present disclosure to enable the CHF-PC to connect with multiple diameter routing agents (DRAs)/OCS for sending/receiving Sy and Gy interface messages.

An object of the present disclosure to maintain a state associated with a subscription permanent identifier (SUPI) across transactions for the same session.

An object of the present disclosure to provide multiple session for the same SUPI for both Sy and Gy.

An object of the present disclosure to enable the CHF-PC to provide local redundancy as well as geo redundant solution.

An object of the present disclosure to create offline usage call data records (CDRs) and optionally create online CDRs.

An object of the present disclosure to provide configurable tables for mapping of http2 and diameter attribute value pair (AVPs) and corresponding values.

An object of the present disclosure is to enable the CHF-PC to make session with OCS for an audio to video upgrade and terminate the session for video to audio downgrade, during an audio call.

An object of the present disclosure is to provide CHF-PC to handle in roamer CC request.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for provisioning interworking of communication networks with radio access technologies (RATs). The system includes one or more processors, and a memory operatively coupled to the one or more processors, wherein the memory includes processor-executable instructions, which on execution, cause the one or more processors to receive a service request from a first charging function based on a first protocol format, wherein the first charging function is associated with a first communication network having a first RAT, convert the received service request to a second protocol format, wherein the second protocol format is associated with a second charging function at a second communication network having a second RAT, receive a response message for the service request based on the second protocol format from the second charging function, and convert the received response message to the first protocol format associated with the first charging function.

In some embodiments, the first communication network having the first RAT may include a fifth-generation network, the second communication network having the second RAT may include a fourth-generation network, the first charging function may include a policy control function (PCF), and the second charging function may include an online charging system (OCS).

In some embodiments, the first protocol format may include a hypertext transfer protocol 2 (HTTP2) and the second protocol format may include a diameter protocol.

In some embodiments, the service request may include at least one of a Nchf_SpendingLimitControl_Subscribe request or a Nchf_SpendingLimitControl_Unsubscribe request and the response message may include at least one of a spending limit answer (SLA) or a session termination answer (STA).

In some embodiments, the processor may be configured to receive a first notification request based on the second protocol format from the second charging function, convert the first notification request based on the second protocol format to a second notification request based on the first protocol format, and transmit the second notification request to the first charging function, wherein the first notification request may include spending status notification request (SNR) and the second notification request may include Nchf_SpendingLimitControl_Notify.

In some embodiments, the processor may be configured to receive a first converged charging request based on the first protocol format from a third charging function associated with the first communication network, convert the first converged charging request based on the first protocol format to a second converged charging request based on the second protocol format, and transmit the second converged charging request to the second charging function, wherein the first converged charging request may include at least one of Nchf_ConvergedCharging_Create, Nchf_ConvergedCharging_Update, or Nchf_ConvergedCharging_Release, and the second converged charging request may include at least one of credit control request initiate (CCR-I), credit control request update (CCR-U), or credit control request terminate (CCR-T).

In some embodiments, the third charging function may include at least one of a charging trigger function (CTF) or a session management function (SMF).

In some embodiments, the first converged charging request may include an audio call converged charging request and the processor may be configured to convert the first converged charging request to the second converged charging request based on the audio call converged charging request including an audio to video upgrade information.

In some embodiments, the processor may be configured to terminate the first converged charging request based on an audio call converged charging request including a video to audio downgrade information.

In some embodiments, the first converged charging request may include an InRoamer converged charging request and the processor may be configured to convert the first converged charging request to the second converged charging request based on a public land mobile network (PLMN) information associated with the InRoamer converged charging request matching a PLMN in a PLMN list.

In some embodiments, the processor may be configured to terminate the first converged charging request based on the PLMN information associated with the InRoamer converged charging request not matching a PLMN in a PLMN list.

In another aspect, the present disclosure relates to a method for provisioning interworking of communication networks with RATs. The method includes receiving, by one or more processors, a service request from a first charging function based on a first protocol format, wherein the first charging function is associated with a first communication network having a first RAT, converting, by the one or more processors, the received service request to a second protocol format, wherein the second protocol format is associated with a second charging function at a second communication network having a second RAT, receiving, by the one or more processors, a response message for the service request based on the second protocol format from the second charging function, and converting, by the one or more processors, the received response message to the first protocol format associated with the first charging function.

In some embodiments, the method may include receiving, by the one or more processors, a first notification request based on the second protocol format from the second charging function, converting, by the one or more processors, the first notification request based on the second protocol format to a second notification request based on the first protocol format, and transmitting, by the one or more processors, the second notification request to the first charging function.

In some embodiments, the method may include receiving, by the one or more processors, a first converged charging request based on the first protocol format from a third charging function associated with the first communication network, converting, by the one or more processors, the first converged charging request based on the first protocol format to a second converged charging request based on the second protocol format, and transmitting, by the one or more processors, the second converged charging request to the second charging function.

In yet another aspect, the present disclosure relates to a non-transitory computer readable medium including one or more instructions stored thereupon that when executed by a processor causes the processor to receive a service request from a first charging function based on a first protocol format, wherein the first charging function is associated with a first communication network having a first RAT, convert the received service request to a second protocol format, wherein the second protocol format is associated with a second charging function at a second communication network having a second RAT, receive a response message for the service request based on the second protocol format from the second charging function, and convert the received response message to the first protocol format associated with the first charging function.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary network architecture (100) in which or with which a proposed system may be implemented, in accordance with embodiments of the present disclosure.

FIG. 2 illustrates an exemplary block diagram representation (200) of a system performing charging function protocol conversion (CHF-PC), in accordance with embodiments of the present disclosure.

FIG. 3 illustrates an exemplary functional architecture (300) of various modules of the CHF-PC, in accordance with embodiments of the present disclosure.

FIG. 4 illustrates an exemplary signal flow diagram (400) for Subscribe, Intermediate Subscribe, and UnSubscribe functions between a policy control function (PCF) and an online charging function (OCS) through the CHF-PC, in accordance with embodiments of the present disclosure.

FIG. 5 illustrates an exemplary signal flow diagram (500) for notification flow between CHF-PC and PCF, in accordance with embodiments of the present disclosure.

FIG. 6 illustrates an exemplary signal flow diagram (600) for converged charging call, in accordance with embodiments of the present disclosure.

FIGS. 7A-7D illustrate exemplary signal flow diagrams (700-A-D) for handling audio call request by the CHF-PC, in accordance with embodiments of the present disclosure.

FIG. 8 illustrates an exemplary signal flow diagram (800) for handling roaming request by the CHF-PC, in accordance with embodiments of the present disclosure.

FIG. 9 illustrates an exemplary functional architecture (900) of the placement of CHF-PC with respect to other network functions, in accordance with embodiments of the present disclosure.

FIG. 10 illustrates an exemplary computer system (1000) in which or with which embodiments of the present disclosure may be implemented.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “CHF” may refer to charging function supporting online charging, offline charging, and convergent charging models in a 5G network.

The term “PCF” may refer to policy control function performing policy control decision and flow-based charging control functionalities for 5G network.

The term “SMF” may refer to session management function for collecting information related to session management from various network components in the 5G core network.

The term “CTF” may refer to charging trigger function generating charging triggers whenever a customer uses services in the 5G network.

The term “OCS” may refer to online charging system allowing a communications service provider to charge customers, in real time, based on service usage in a 4G network.

In some aspects, the present disclosure provides a charging function protocol converter (CHF-PC) for converting a charging function (CHF) associated with a 5G network to an existing online charging system (OCS) associated with a 4G network. In some embodiments, the CHF-PC converts messages from the CHF in the 5G network to a format compatible with OCS in the 4G network. In one embodiment, the CHF-PC converts the spending limit control subscribe/unsubscribe request from a PCF to a spending limit request for processing by the OCS. In another embodiment, the CHF-PC converts a spending request notification from the OCS to a spending limit control notification for processing by the CHF. In one another embodiment, the CHF-PC converts a converged charging request from a CTF or SMF to a credit control request for processing by the OCS.

In some embodiments, the CHF-PC may suppress online triggers to the OCS. For example, without limitations, during a multimedia call and InRoamer request, the CHF-PC may or may not forward the request the OCS based on the service type associated with the request.

In some embodiments, the CHF-PC may be provided within the 5G core network and may serve as an edge interface for communicating with the existing 4G network.

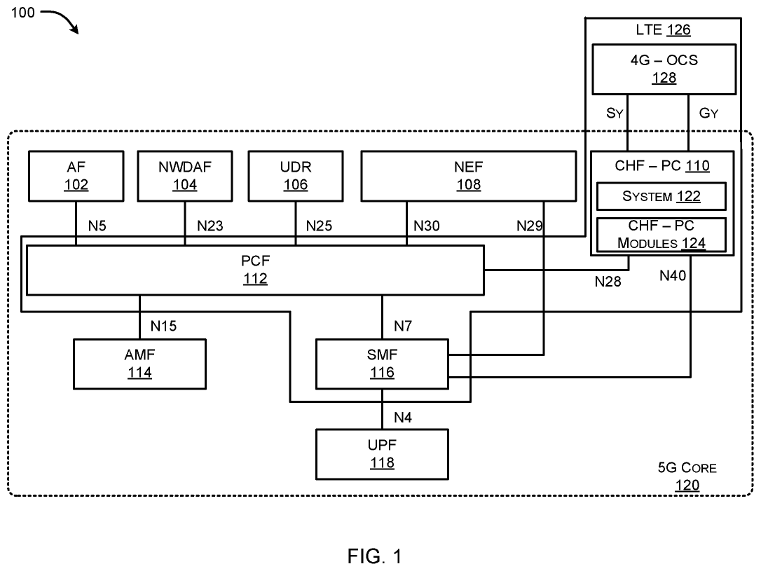

The various embodiments throughout the disclosure will be explained in more detail with reference to FIGS. 1-10.

FIG. 1 illustrates an exemplary network architecture (100) in which or with which a proposed system may be implemented, in accordance with embodiments of the present disclosure.

Referring to FIG. 1, the network (100) includes a 5G core network (120) interworking with a 4G network (126). The 5G core network (120) may include an application function (AF) (102) handling traffic and quality of service, a network data analytics function (NWDAF) (104) collecting data and performing analytics, a unified data repository (UDR) (106) storing data for use by various network functions, a network exposure function (NEF) (108) securely exposing the capabilities of network functions, a policy control function (PCF) (112) performing policy control decision and flows based charging control functionalities, an access and mobility management function (AMF) (114) controlling access of user equipment to the 5G core (120) and managing the mobility of the UEs, a session management function (SMF) (116) managing user sessions in the 5G core (120), and a user plane function (UPF) (118) connecting data from a radio access network (RAN) to the internet.

Referring to FIG. 1, the 5G core (120) may further include a charging function protocol converter (CHF-PC) (110) to connect to existing charging function, for example, without limitation, online charging system (OCS) (128) of the 4G network (126). The CHF-PC (110) may serve as an edge interface for connecting the 5G core (120) with the 4G network (126), enabling interworking between the two networks. Further, the CHF-PC (110) may convert the HTTP2 protocol messages associated with the charging function, for example, without limitations, the PCF (112) or the SMF (116) of the 5G core (12) to diameter protocol messages associated with the OCS (128) of the 4G network (126).

Referring to FIG. 1, the CHF-PC (110) may include a system (122) and CHF-PC modules (124) for performing the conversion. The CHF-PC (110) may perform protocol conversion of the charging function of the 5G core (120) to the charging function of the 4G network (126) and enable the CHF of the 5G core (120) to work with the existing 4G network (126) without many changes to the existing business support system (BSS) associated with the 4G network (126).

The CHF-PC (110) may provide the protocol conversion support from HTTP/2 format to Diameter format and vice versa. In an embodiment, the CHF-PC (110) may make a mapping matrix for HTTP/2 information elements (IEs) (used by CHF) to Diameter attribute value pairs (AVP) (as used by OCS) as well as mapping for service operation with command code. For example, without limitations, the mapping matrix may include:
(i) SUPI (5G)→SubscriptionIdentifier-subId-IMSI (444),
(ii) GPSI (5G)→SubscriptionIdentifier-subId-MSISDN (444),
(iii) PolicyCounterIds (5G)→PolicyCounterIdAvp (2901),
(iv) PolicyCounterInfo (5G)→PolicyCounterStatusReport (2903),
(v) CC-Request-Type (4G)→Create/Update/Delete Service Operation for Nchf_ConvergedCharging Service.

In some embodiments, the CHF-PC (110) may register with a network repository function (NRF) as a standard network function (NF) “CHF” with standard NFProfile parameters.

In some embodiments, the CHF-PC (110) may integrate with a service communication proxy (SCP) (as static and optional for discovery via NRF) for service operations as supported by standard NF “CHF” and may support routing via the SCP.

In some embodiments, the CHF-PC (110) may provide user configurable tables for mapping table values for certain diameter AVPs such as Service-Context-Id, Serving-Node-Type, user location, etc.

In some embodiments, while performing protocol conversion from HTTP2 to diameter and vice versa, the CHF-PC (110) may maintain the session data and corresponding conversion mapping. For example, without limitations, a complete Sy session of the OCS (128) for a subscriber may contain a spending limit request (SLR), a spending status notification request (SNR), and a session termination request (STR) and the CHF-PC (110) may maintain these session states for the subscriber so that individual transaction could be mapped to proper session at both Diameter and HTTP/2 sides. In an embodiment, the sessions may include Gy sessions and the CHF-PC (110) may maintain the Gy session states.

In some embodiments, the CHF-PC (110) may create usage call data records (CDRs) for offline and online charging.

In some embodiments, the CHF-PC (110) may provide local redundancy using in synch microservice or making use of database for maintaining the session state. The CHF-PC (110) may also provide redundancy across geographic sites, wherein the CHF-PC (110) database may be replicated across geo location so that in case of unavailability of local CHF-PC clusters, subscriber may use the geo CHF-PC cluster for current ongoing sessions as well as new sessions.

In one embodiment, the CHF-PC (110) may convert the spending limit control subscribe/unsubscribe, for example,

Nchf_SpendingLimitControl_Subscribe request or a Nchf_SpendingLimitControl_Unsubscribe request from the PCF (112) to a spending limit request (SLR) or a session termination request (STR), respectively for processing by the OCS (128). The OCS (128) may respond with a spending limit answer (SLA) or a session termination answer (STA) which may be converted to 201 created content or 204 no content messages associated with the PCF (112) in the 5G core (120).

In another embodiment, the CHF-PC (110) may convert a spending request notification (SNR) from the OCS (128) to a spending limit control notification, for example, Nchf_Spending Limit Control_Notify, for processing by the PCF (112).

In one another embodiment, the CHF-PC (110) may convert a converged charging request, for example, Nchf_Spending Limit Control_Notify, from a CTF or SMF (116) to a credit control request (CCR) for processing by the OCS (128).

In some embodiments, the 4G network (126) may include an offline charging function (OFCS) in the place of OCS (128) or along with the OCS (128).

In some embodiments, a first charging function based on a first protocol or a first protocol format may be associated with a first communication network using a first radio access technology (RAT) and a second charging function based on a second protocol or a second protocol format may be associated with a second communication network using a second RAT, wherein the first RAT may be different from the second RAT. The CHF-PC (110) may convert the first protocol signals to second protocol signal and vice versa.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

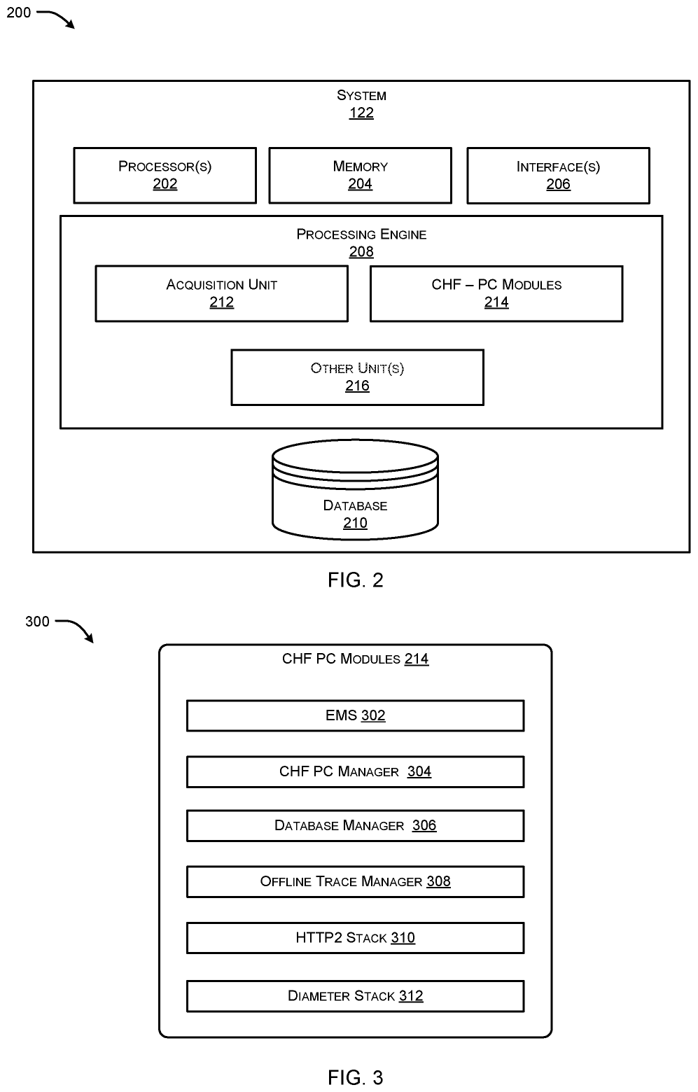

FIG. 2 illustrates an exemplary block diagram representation (200) of a system performing charging function protocol conversion (CHF-PC), in accordance with embodiments of the present disclosure.

Referring to FIG. 2, the system (122) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (122). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as Random-Access Memory (RAM), or non-volatile memory such as Electrically Erasable Programmable Read-only Memory (EPROM), flash memory, and the like.

In an embodiment, the system (122) may include an interface(s) (206). The interface(s) (206) may comprise a variety of interfaces, for example, interfaces for data input and output devices, referred to as input/output (I/O) devices, storage devices, and the like. The interface(s) (206) may facilitate communication for the system (122). The interface(s) (206) may also provide a communication pathway for one or more components of the system (122). Examples of such components include, but are not limited to, processing unit/module(s) (208) and a database (210).

The processing unit/module(s) (208) may be implemented as a combination of hardware and programming (for example, programmable instructions) to implement one or more functionalities of the processing module(s) (208). In examples described herein, such combinations of hardware and programming may be implemented in several different ways. For example, the programming for the processing module(s) (208) may be processor-executable instructions stored on a non-transitory machine-readable storage medium and the hardware for the processing unit(s) (208) may comprise a processing resource (for example, one or more processors), to execute such instructions. In the present examples, the machine-readable storage medium may store instructions that, when executed by the processing resource, implement the processing unit(s) (208). In such examples, the system (122) may include the machine-readable storage medium storing the instructions and the processing resource to execute the instructions, or the machine-readable storage medium may be separate but accessible to the system (208) and the processing resource. In other examples, the processing unit(s) (208) may be implemented by electronic circuitry. In an aspect, the database (210) may comprise data that may be either stored or generated as a result of functionalities implemented by any of the components of the processor (202) or the processing units (208).

In an embodiment, the processing unit (208) may include one or more units/modules such as, but not limited to, an acquisition unit (212), charging function protocol convert (CHF-PC) modules (214), and other unit(s) (216).

Referring to FIG. 2, the database (210) may store data related to a session state. In some embodiments, the database (210) may be replicated across different geo locations to maintain a state of the current ongoing session as well as new session.

In one embodiment, the one or more processor(s) (202) may enable the CHF-PC modules (214) to convert the messages from the first charging function based on the first protocol to messages that may be compliant with a second charging function based on the second protocol. The first charging function may be associated with the first communication network and the second charging function may be associated with the second communication network. In an example embodiment, the first communication network may include 5G core network (120) and the second communication network may include 4G network (126), as shown in FIG. 1. Further, the first charging function may include the PCF (112), SMF (116) or the CTP and the second charging function may include the OCS (126) or the OFCS. The first protocol may include the HTTP2 protocol and the second protocol may include the diameter protocol.

In some embodiments, the CHF-PC modules (214) may convert messages from HTTP2 protocol format to diameter protocol format and vice versa, thereby supporting the 5G core charging function CHF using the BSS of the existing 4G network.

A person of ordinary skill in the art will appreciate that the exemplary block diagram (200) may be modular and flexible to accommodate any kind of changes in the system (122).

FIG. 3 illustrates an exemplary functional architecture (300) of various modules of the CHF-PC, in accordance with embodiments of the present disclosure.

Referring to FIG. 3, the CHF-PC module (214) includes an element management system (EMS) (302), a CHF-PC manager (304), a database manager (306), an offline trace manager (308), HTTP2 stack (310), and a diameter stack (312). The EMS (302) provides a user interface for centralized management of network repository function (NRF) and may perform functions such as, without limitations, performance management, fault management, backup and restore, configuration management, management dashboard, etc.

Referring to FIG. 3, the CHF-PC manager (304) hosts procedures and business logic as per the communication network standards. The CHF-PC manager (304) provides middleware services, thereby assisting the various components of cluster or module to interact and exchange data and maintain availability of the service. Further, the database manager (306) acts as an interface for application function to connect and fetch data from a database cluster.

Referring to FIG. 3, the offline trace manager (308) assists in tracing a control flow and action taken for a request processing. The CHF-PC module (214) may be integrated with any analytics platform for offline trace management. The CHF-PC (214) uses the HTTP2 stack for interacting with all the Network Functions (NFs), for example, the PCF (112) and the SMF (116) shown in FIG. 1.

Further, the CHF-PC module (214) uses diameter stack for interacting with the OCS (128) as shown in FIG. 1.

A person of ordinary skill in the art will appreciate that the exemplary functional architecture (300) of the CHF-PC module (214) may be modular and flexible to accommodate any kind of changes in the functionality of the CHF-PC (110) as shown in FIG. 1.

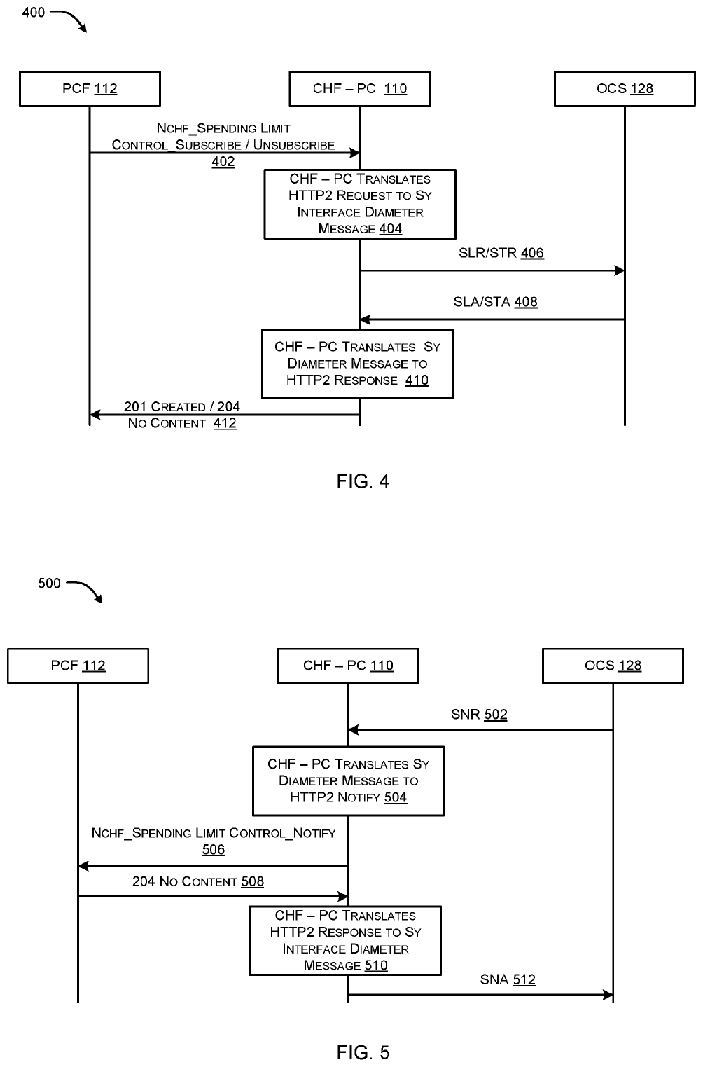

FIG. 4 illustrates an exemplary signal flow diagram (400) for Subscribe, Intermediate Subscribe and UnSubscribe functions between a policy control function (PCF) and an online charging function (OCS) through the CHF-PC, in accordance with embodiments of the present disclosure.

Referring to FIG. 4, when there is a new charging function subscribe or unsubscribe request in the 5G core (120) as shown in FIG. 1, the PCF (112) may send a Nchf_Spending Limit Control_Subscribe/Unsubscribe request, at step 402, to the CHF-PC (110). The CHF-PC (110) may convert, at step 404, the Nchf_Spending Limit Control_Subscribe/Unsubscribe request from the PCF (112) to a form compatible with OCS (128) present in the 4G network (126) as shown in FIG. 1. For example, the CHF-PC (110) may convert the HTTP2 protocol based Nchf_SpendingLimitControl_Subscribe/Nchf_SpendingLimitControl_Unsubscribe request from the PCF (112) to a diameter protocol-based spending limit request (SLR)/session termination request (STA), respectively, response on an Sy interface.

Referring to FIG. 4, the CHF-PC (110) may send the converted SLR/STA request to the OCS (128) at step 406. Further, the OCS (128) may respond with spending limit answer (SLA) or a session termination answer (STA) to the CHF-PC (110) at step 408. Upon receiving the response, the CHF-PC (110) may convert, at step 410, the Sy diameter message response to a HTTP2 protocol response message 201 created/204 No content and transmit the converted message to the PCF (112) at step 412.

In some embodiments, the CHF-PC (110) may refer to a conversion matrix to perform the conversion from HTTP2 to Diameter protocol and vice versa.

FIG. 5 illustrates an exemplary signal flow diagram (500) for notification flow between CHF-PC and PCF, in accordance with embodiments of the present disclosure.

Referring to FIG. 5, the OCS (128) at step 502 may send a diameter protocol-based spending status notification request (SNR) to the CHF-PC (110) over the Sy interface. The CHF-PC (110) may, at step 504, translate the diameter protocol-based SNR request to a HTTP2 based Nchf_SpendingLimitControl_Notify request. Further, the CHF-PC (110) may, at step 506, transmit the Nchf_SpendingLimitControl_Notify request to the PCF (112). The PCF (112) may, at step 508, respond with a 204 No content message to the CHF-PC (110). The CHF-PC (110) may at step 510, translate the HTTP2 protocol response to a Sy interface-based diameter response status notification answer (SNA) and transmit the SNA to the OCS (128) at step 512.

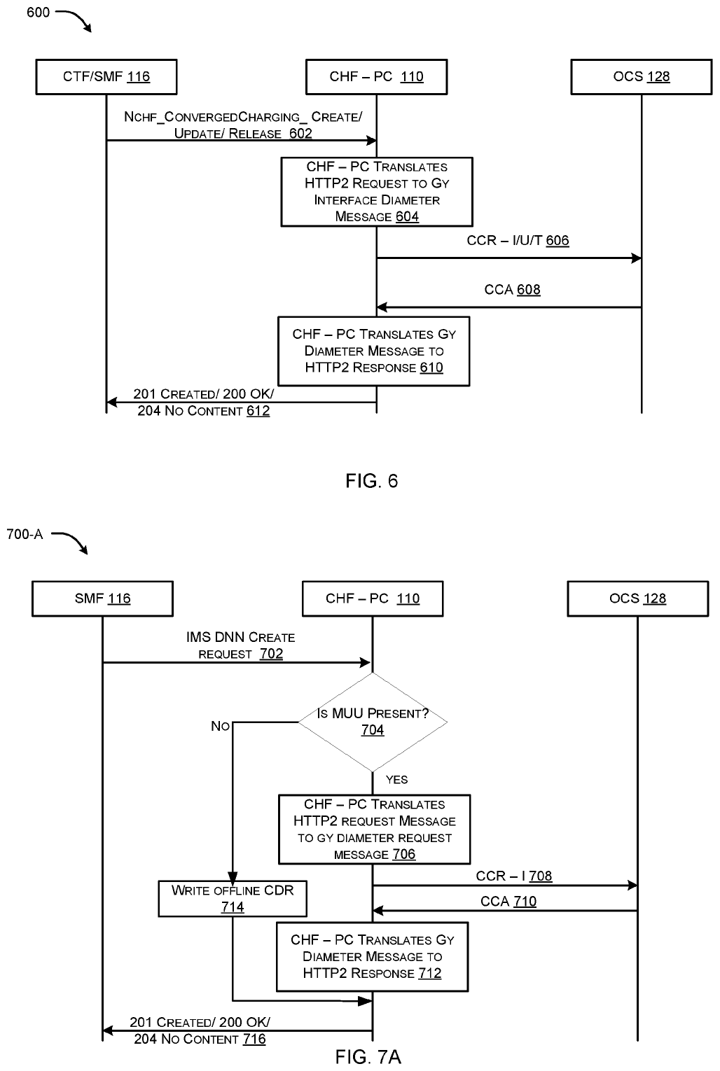

FIG. 6 illustrates an exemplary signal flow diagram (600) for converged charging call, in accordance with embodiments of the present disclosure.

Referring to FIG. 6, the CTF/SMF (116) may, at step 602, send a HTTP2 based Nchf_ConvergedCharging_Create request or Nchf_ConvergedCharging_Update request or Nchf_ConvergedCharging_Release request to the CHF-PC (110). The CHF-PC (110) may, at step 604, convert or translate the HTTP2 request to a diameter protocol based converged charging request message for example, a credit control request initiate (CCR-I), a credit control request update (CCR-U), or a credit control request terminate (CCR-T), respectively, over a Gy interface. Further, the CHF-PC (110) may, at step 606, transmit the converted CCR-I/CCR-U/CCR-T messages to the OCS (128). Upon receiving the converged charging messages, the OCS (128) may, at step 608, send a diameter protocol-based credit control answer (CCA) message to the CHF-PC (110) over Gy interface. The CHF-PC (110) may at step 612, translate the CCR-I/CCR-U/CCR-T message from the OCS (128) to either one of HTTP2 based 201 created/200 Ok/204 No connect message respectively. The CHF-PC (110) may, at step 612, further transmit the converted messages to the CTP/SMF (116).

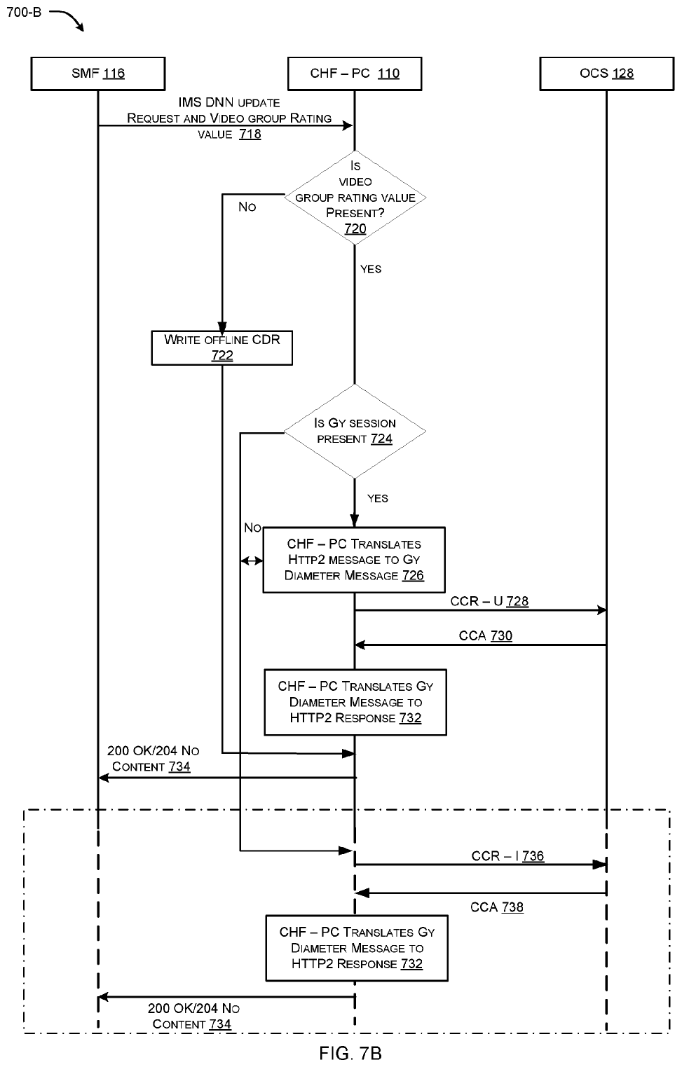

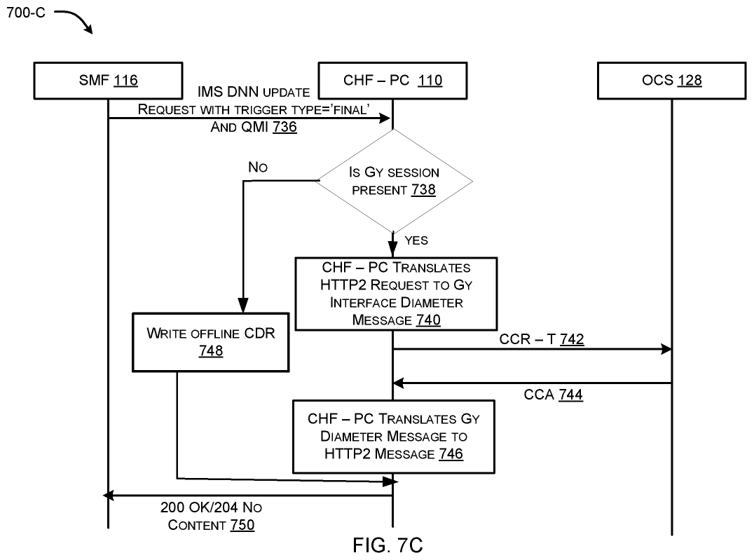

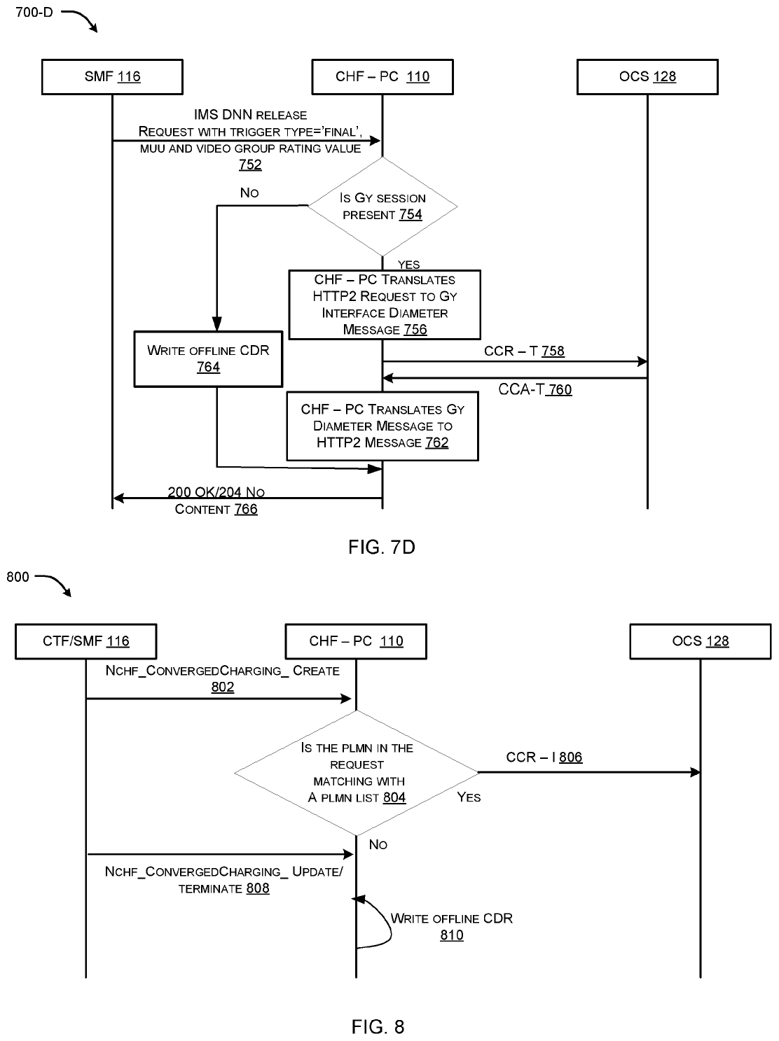

FIGS. 7A-7D illustrate exemplary signal flow diagrams (700-A-D) for handling audio call request by the CHF-PC, in accordance with embodiments of the present disclosure.

In some embodiments, the CHF-PC (110) may maintain session locally for all the audio call converged charging requests from SMF (116). CHF-PC (110) may create session with OCS (128) for audio to video upgrade and terminate the session for video to audio downgrade.

FIG. 7A illustrates an exemplary signal flow diagram (700-A) during an internet protocol multimedia subsystem (IMS) message domain network name (DNN) create request from the SMF, in accordance with some embodiments of the present disclosure.

Referring to FIG. 7A, the SMF (116) may, at step 702, send an internet protocol multimedia subsystem (IMS) message domain network name (DNN) create request to the OCS (128) through the CHF-PC (110). The CHF-PC (110), upon receiving the request may, at step 704, check if the IMS DNN create request includes a multiple unit usage (MUU). If the MUU is absent in the IMS DNN create request, the CHF-PC (110) may, at step 714, write offline CDR and proceed with step 716. On the other hand, if the IMS DNN create request includes the MUU, the CHF-PC (110) may, at step 706 convert the HTTP2 request message to a Gy diameter message. The CHF-PC (110) may, at step 708, send a CCR-I to the OCS (128) over the Gy interface. The OCS (128) may, at step 710, send CCA to the CHF-PC (110). The CHF-PC (110) may at step 712, translate the CCA message over the Gy interface to a HTTP2 message. The CHF-PC (110) may at step 716, transmit the translated message to the SMF (116).

FIG. 7B illustrates an exemplary signal flow diagram (700-B) during an IMS DNN update request from the SMF, in accordance with some embodiments of the present disclosure.

Referring to FIG. 7B, the SMF (116) may at step 718, send an IMS DNN update request along with a video group rating value to the CHF-PC (110), wherein the video group rating value may be configured by a network operator. The CHF-PC (110) may at step 720, determine if the video group rating value is present in the received request. If the video group rating value is not present (absent), the CHF-PC (110) may at step 722, write offline CDR and proceed with step 734. On the other hand, if the video group rating value is present, CHF-PC (110) may at step 724, determine if a session is present over the Gy interface. If the session is present, the CHF-PC (110) may at step 726, translate the received HTTP2 message to a Gy interface message. The CHF-PC (110) may at step 728 send a CCR-U message to the OCS (128). The OCS (128) may at step 730 respond with a CCA. The CHF-PC (110) may at step 732 translate the diameter message over the Gy interface to a HTTP2 response message. The CHF-PC (110) may at step 734, transmit the translated message to the SMF (116). On the other hand, if there is no session over the Gy interface, the. CHF-PC (110) may perform the translation at step 726. The CHF-PC (110) may at step 736 send a CCR-I to the OCS (128). The CHF-PC (110) may at step 738, receive a CCA from the OCS (128). The CHF-PC (110) may then proceed with performing the steps 732 and 734.

FIG. 7C illustrates an exemplary signal flow diagram (700-C) during an IMS DNN update request with a trigger type=‘final’ from the SMF, in accordance with some embodiments of the present disclosure.

Referring to FIG. 7C, the SMF (116) may at step 734, send an IMS DNN update request with a trigger type=‘final’ with an online rating group or a quota management indicator (QMI) based on the HTTP2 protocol to the CHF-PC (110). The CHF-PC (110) may at step 738, determine if a Gy session is present. If the Gy session is present, the CHF-PC (110) may at step 740, translate the received IMS DNN update request with a trigger type=‘final’ with the (QMI) based on HTTP2 protocol to a CCR-T message over the Gy interface. The CHF-PC (110) may at step 742, send the CCR-T message to the OCS (128). The OCS (128) may at step 744 send a CCA message to the CHF-PC (110). The CHF-PC (110) may at step 746, translate the Gy interface response message (CCA) to a HTTP2 compatible response message and may further at step 750, transmit the 200/204 code to the SMF (116). On the other hand, if the Gy session is not present, the CHF-PC (110) may at step 748 write offline CDR and may proceed to perform the step 750.

FIG. 7D illustrates an exemplary signal flow diagram (700-D) during an IMS DNN update request with a trigger type=‘final’ from the SMF, in accordance with embodiments of the present disclosure.

Referring to FIG. 7D, the SMF (116) may at step 752, send an IMS DNN release request with a trigger type=‘final’ with the MUU along with the video group rating value based on HTTP2 protocol to the CHF-PC (110). The CHF-PC (110) may at step 754, determine if a Gy session is present. If the Gy session is present, the CHF-PC (110) may at step 756, translate the received release request based on HTTP2 protocol to a CCR-T message over the Gy interface. The CHF-PC (110) may at step 758, send the CCR-T message to the OCS (128). The OCS (128) may at step 760, send a CCA-T message to the CHF-PC (110). The CHF-PC (110) may at step 762, translate the Gy interface message to a HTTP2 response message. The CHF-PC (110) may at step 766, transmit the response message to the SMF (116). On the other hand, if the session is not present over the Gy interface, the CHF-PC (110) may at step 764 write offline CDR and proceed to send at step 766, the response message to the SMF (116).

FIG. 8 illustrates exemplary signal flow diagrams (800) for handling roaming request by the CHF-PC, in accordance with embodiments of the present disclosure.

Referring to FIG. 8, the CTF (116) may at step 802, send a Nchf_ConvergedCharging_Create request to the CHF-PC (110). The CHF-PC (110) may at step 804, determine if a public land mobile network (PLMN) in the create request has a match in a PLMN list. If there is a match, the CHF-PC (110) may at step 806 sends a CCR-I to the OCS (128). On the other hand, if there is no match present, the CHF-PC (110) may at step 810, write offline CDR for any Nchf_ConvergedCharging_Update/terminate request received from the CTP at step 808.

In some embodiments, an isInRoamerEnabled runtime configurable flag added in CHF-PC (110) to activate InRoamer call flow, otherwise CHF-PC (110) may forward online trigger to the OCS (128).

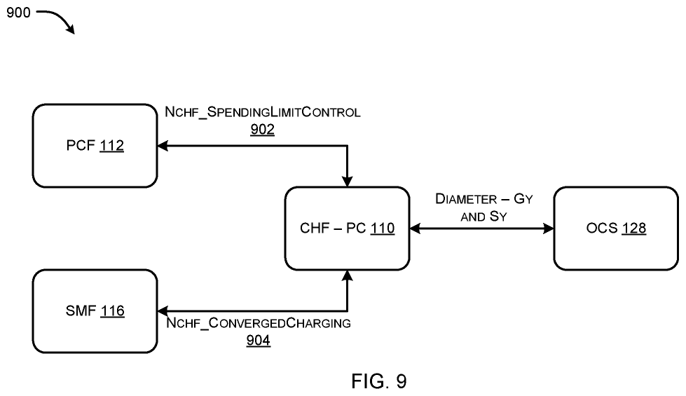

FIG. 9 illustrates an exemplary functional architecture (900) of the placement of CHF-PC with respect to other network functions, in accordance with embodiments of the present disclosure.

Referring to FIG. 9, the CHF-PC (110) may be placed as an edge interface in the 5G core network (120) as shown in FIG. 1. The CHF-PC (110) may translate charging request messages (902) from the PCF (112) or the converged charging request messages (904) from the SMF (116) to diameter messages over both the Sy and Gy interfaces compatible with the OCS (128). The CHF-PC (110) may serve as an edge interface protocol converter for converting charging messages from the HTTP2 protocol associated with the 5G network to the charging messages based on the diameter protocol associated with the 4G network and vice versa.

A person of ordinary skill in the art will appreciate that these are mere examples, and in no way, limit the scope of the present disclosure.

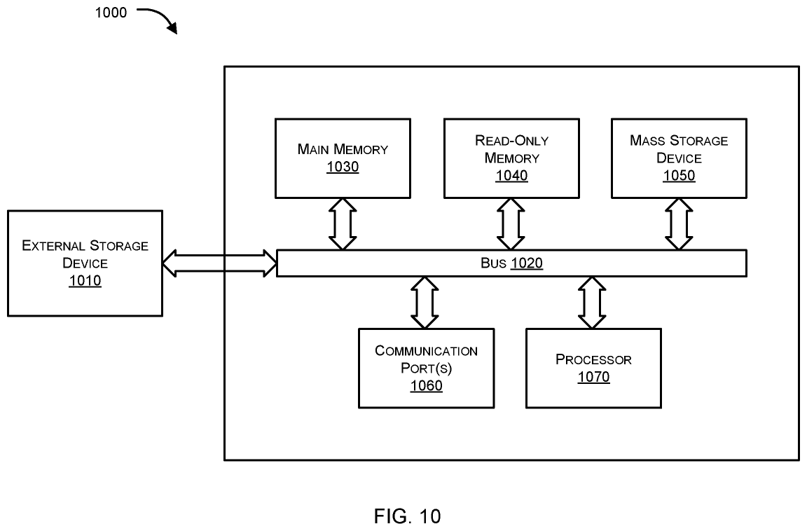

FIG. 10 illustrates an exemplary computer system (1000) in which or with which embodiments of the present disclosure may be utilized.

As shown in FIG. 10, the computer system (1000) may include an external storage device (1010), a bus (1020), a main memory (1030), a read-only memory (1040), a mass storage device (1050), communication port(s) (1060), and a processor (1070). A person skilled in the art will appreciate that the computer system (1000) may include more than one processor and communication ports. The processor (1070) may include various modules associated with embodiments of the present disclosure. The communication port(s) (1060) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (1060) may be chosen depending on a network, such a Local Area Network (LAN), Wide Area Network (WAN), or any network to which the computer system (1000) connects. The main memory (1030) may be random access memory (RAM), or any other dynamic storage device commonly known in the art. The read-only memory (1040) may be any static storage device(s) including, but not limited to, a Programmable Read Only Memory (PROM) chips for storing static information e.g., start-up or basic input/output system (BIOS) instructions for the processor (1070). The mass storage device (1050) may be any current or future mass storage solution, which may be used to store information and/or instructions.

The bus (1020) communicatively couples the processor (1070) with the other memory, storage, and communication blocks. The bus (1020) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (1070) to the computer system (1000).

Optionally, operator and administrative interfaces, e.g. a display, keyboard, and a cursor control device, may also be coupled to the bus (1020) to support direct operator interaction with the computer system (1000). Other operator and administrative interfaces may be provided through network connections connected through the communication port(s) (1060). In no way should the aforementioned exemplary computer system (1000) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure provides integration of 5G core charging function (CHF) with existing online charging system (OCS) over legacy 4G interfaces.

The present disclosure integrates existing business support system (BSS) with the CHF without introducing major challenges and avoiding customization.

The present disclosure integrates charging usage for non-combo packet data network gateway (PGW) vs session management function (SMF) by providing common hypertext transfer protocol/2 (HTTP/2) interface.

The present disclosure provides capability of generating Offline usage call data records (CDRs) which may either be used for billing settlement or may be used for validating the CDRs generated at SMF/PGW.

The present disclosure provides a user-friendly command Line interface and an embedded database with CHF.

The present disclosure provides robust element management system for fault, configuration, accounting, performance and security (FCAPS).

The present disclosure supports N28 and N40 interfaces over HTTP/2 and Sy and Gy interfaces over diameter protocol.

I/We claim:

1. A system (122) for provisioning interworking of communication networks, said system (122) comprising:
one or more processors (202); and
a memory (204) operatively coupled to the one or more processors (202), wherein the memory (204) comprises processor-executable instructions, which on execution, cause the one or more processors (202) to:
receive a service request from a first charging function based on a first protocol format, wherein the first charging function is associated with a first communication network having a first radio access technology (RAT);
convert the received service request to a second protocol format, wherein the second protocol format is associated with a second charging function at a second communication network having a second RAT;
receive a response message for the service request based on the second protocol format from the second charging function; and
convert the received response message to the first protocol format associated with the first charging function.

2. The system (122) as claimed in claim 1, wherein the first communication network having the first RAT comprises a fifth-generation network, and wherein the second communication network having the second RAT comprises a fourth-generation network.

3. The system (122) as claimed in claim 1, wherein the first charging function comprises a policy control function (PCF) (112) and the second charging function comprises an online charging system (OCS) (128).

4. The system (122) as claimed in claim 1, wherein the first protocol format comprises a hypertext transfer protocol 2 (HTTP2) and the second protocol format comprises a diameter protocol.

5. The system (122) as claimed in claim 1, wherein the service request comprises at least one of: a Nchf_SpendingLimitControl_Subscribe request or a Nchf_SpendingLimitControl_Unsubscribe request.

6. The system (122) as claimed in claim 1, wherein the response message comprises at least one of: a spending limit answer (SLA) or a session termination answer (STA).

7. The system (122) as claimed in claim 1, wherein the memory (204) comprises processor-executable instructions, which on execution, cause the one or more processors (202) to:
receive a first notification request based on the second protocol format from the second charging function;
convert the first notification request based on the second protocol format to a second notification request based on the first protocol format; and
transmit the second notification request to the first charging function.

8. The system (122) as claimed in claim 7, wherein the first notification request comprises spending status notification request (SNR) and the second notification request comprises Nchf_SpendingLimitControl_Notify.

9. The system (122) as claimed in claim 1, wherein the memory (204) comprises processor-executable instructions, which on execution, cause the one or more processors (202) to:
receive a first converged charging request based on the first protocol format from a third charging function associated with the first communication network;
convert the first converged charging request based on the first protocol format to a second converged charging request based on the second protocol format; and
transmit the second converged charging request to the second charging function.

10. The system (122) as claimed in claim 9, wherein the first converged charging request comprises at least one of: Nchf_ConvergedCharging_Create, Nchf_ConvergedCharging_Update, or Nchf_ConvergedCharging_Release, and wherein the second converged charging request comprises at least one of: credit control request initiate (CCR-I), credit control request update (CCR-U), or credit control request terminate (CCR-T).

11. The system (122) as claimed in claim 9, wherein the third charging function comprises at least one of: a charging trigger function (CTF) or a session management function (SMF) (116).

12. The system (122) as claimed in claim 9, wherein the first converged charging request comprises an audio call converged charging request.

13. The system (122) as claimed in claim 12, wherein the memory (204) comprises processor-executable instructions, which on execution, cause the one or more processors (202) to:
convert the first converged charging request to the second converged charging request based on the audio call converged charging request comprising an audio to video upgrade information.

14. The system (122) as claimed in claim 12, wherein the memory (204) comprises processor-executable instructions, which on execution, cause the one or more processors (202) to:
terminate the first converged charging request based on the audio call converged charging request comprising a video to audio downgrade information.

15. The system (122) as claimed in claim 9, wherein the first converged charging request comprises an InRoamer converged charging request.

16. The system (122) as claimed in claim 15, wherein the memory (204) comprises processor-executable instructions, which on execution, cause the one or more processors (202) to:
convert the first converged charging request to the second converged charging request based on a public land mobile network (PLMN) information associated with the InRoamer converged charging request matching a PLMN in a PLMN list.

17. The system (122) as claimed in claim 16, wherein the memory (204) comprises processor-executable instructions, which on execution, cause the one or more processors (202) to:
terminate the first converged charging request based on the PLMN information associated with the InRoamer converged charging request not matching the PLMN in the PLMN list.

18. A method for provisioning interworking of communication networks the method comprising:
receiving, by one or more processors (202), a service request from a first charging function based on a first protocol format, wherein the first charging function is associated with a first communication network having a first radio access technology (RAT);
converting, by the one or more processors (202), the received service request to a second protocol format, wherein the second protocol format is associated with a second charging function at a second communication network having a second RAT;
receiving, by the one or more processors (202), a response message for the service request based on the second protocol format from the second charging function; and
converting, by the one or more processors (202), the received response message to the first protocol format associated with the first charging function.

19. The method as claimed in claim 18, wherein the service request comprises at least one of: a Nchf_SpendingLimitControl_Subscribe request or a Nchf_SpendingLimitControl_Unsubscribe request, and the response message comprises at least one of: a spending limit answer (SLA) or a session termination answer (STA).

20. The method as claimed in claim 18, comprising:
receiving, by the one or more processors (202), a first notification request based on the second protocol format from the second charging function;
converting, by the one or more processors (202), the first notification request based on the second protocol format to a second notification request based on the first protocol format; and
transmitting, by the one or more processors (202), the second notification request to the first charging function.

21. The method as claimed in claim 20, wherein the first notification request comprises spending status notification request (SNR) and the second notification request comprises Nchf_SpendingLimitControl_Notify.

22. The method as claimed in claim 18, comprising:
receiving, by the one or more processors (202), a first converged charging request based on the first protocol format from a third charging function associated with the first communication network;
converting, by the one or more processors (202), the first converged charging request based on the first protocol format to a second converged charging request based on the second protocol format; and
transmitting, by the one or more processors (202), the second converged charging request to the second charging function.

23. The method as claimed in claim 22, wherein the first converged charging request comprises at least one of: Nchf_ConvergedCharging_Create, Nchf_ConvergedCharging_Update, or Nchf_ConvergedCharging_Release, and the second converged charging request comprises at least one of: credit control request initiate (CCR-I), credit control request update (CCR-U), or credit control request terminate (CCR-T).

24. The method as claimed in claim 22, wherein the first communication network comprises a fifth-generation network, the first charging function comprises a policy control function (PCF) (112), and the third charging function comprises at least one of: a charging trigger function (CTF) or a session management function (SMF) (116).

25. The method as claimed in claim 18, wherein the second communication network comprises a fourth-generation network and the second charging function comprises an online charging function (OCS) (128).

26. A non-transitory computer readable medium that comprises one or more instructions stored thereupon that when executed by a processor causes the processor to:
receive a service request from a first charging function based on a first protocol format, wherein the first charging function is associated with a first communication network having a first radio access technology (RAT);
convert the received service request to a second protocol format, wherein the second protocol format is associated with a second charging function at a second communication network having a second RAT;
receive a response message for the service request based on the second protocol format from the second charging function; and
convert the received response message to the first protocol format associated with the first charging function.
